(19) United States
(12) Patent Application Publication
(10) Pub. No.: US 2023/0022392 A1
(43) Pub. Date: Jan. 26, 2023

(54) SENSOR DEVICE FOR A FUEL CELL SYSTEM

(71) Applicant: AVL List GmbH, Graz (AT)

(72) Inventor: Ulla-Valentina KRUSCH, Preding (AT)

(73) Assignee: AVL List GmbH, Graz (AT)

(21) Appl. No.: 17/785,919

(22) PCT Filed: Dec. 18, 2020
(86) PCT No.: PCT/AT2020/060482

§ 371 Date: Jun. 16, 2022

(30) Foreign Application Priority Data
Dec. 18, 2019 (AT) A51114/2019

(51) Int. Cl. H01M 8/04223; H01M 8/0444; H01M 8/04537; H01M 8/04746; H01M 8/2465; G01N 27/407

(52) U.S. Cl. CPC H01M 8/04231; H01M 8/04447; H01M 8/04559; H01M 8/04753; H01M 8/2465; G01N 27/407

(57) ABSTRACT

The present invention relates to a sensor device (10) for a fuel cell system (100) for determining a purging parameter (SP) for controlling a purging process of the fuel cell system (100), comprising a first flow channel (20) for arranging in an anode feed section (122) of an anode section (120) of a fuel cell stack (110) and a second flow channel (130) for arranging in a recirculation section (126) of the anode section (120) of the fuel cell stack (110), which are separated from each other, at least in sections, by means of a gas-tight membrane (40), wherein the membrane (40) is designed to be permeable for protons and has an electrode section (42, 44) on both sides, as well as comprising a measuring device (50) for determining a fuel concentration difference between the first flow channel (20) and the second flow channel (30) as a purging parameter (SP) based on an electrical voltage between the two electrode sections (42, 44).

The present invention relates to a sensor device for a fuel cell system, a fuel cell system with such a sensor and a method for controlling a purging process of a fuel cell system.

It is known that fuel cells perform a recirculation of fuel during operation. The fuel is, for example, hydrogen, which is fed to an anode side of the fuel cell and chemically reacted there. However, in the usual mode of operation, a residue of the fuel remains in the anode exhaust gas after the anode. In order to be able to reuse this remaining residual fuel, it is known for at least a part of the anode exhaust gas to be returned to the anode feed section in a recirculation section.

A disadvantage of the known solutions is that contamination can occur in the anode feed section and thus in the anode of the fuel cell stack due to the recirculation described above. Through diffusion processes, it is possible that nitrogen can get into the anode exhaust gas and is fed back into the anode feed section through the recirculation and as a result thus also accumulates. Water or water vapour can also be found in an anode exhaust gas which is also fed in liquid form, as droplets, into the anode feed section through the recirculation, where it can also block paths in the hydrogen path. Furthermore, due to damage mechanisms, small amounts of carbon monoxide and carbon dioxide can form on the anode side. In order to avoid an excessive degree of contamination in the gas of the anode feed section, a purging process is therefore carried out in the known fuel cell systems. A distinction is made in particular between purging and bleeding processes. Purging processes involve a short-term draining or purging of the anode feed section, while a bleeding process is understood to mean a longer-term draining or purging with low volume flows.

In the known solutions, the timing of the purging process is either initiated if the cell voltage of individual cells of the fuel cell stack falls below a certain level or is determined algorithmically on the basis of a simulation model. This simulates which impurities are produced in the anode feed section, over which period of operation and under which operating conditions. The purging process is then carried out on the basis of this simulation result. In order to avoid a summing-up of simulation errors, a larger number of purging processes is carried out, to be on the safe side. On the one hand, this is disadvantageous since it limits the operation of the fuel cell. A further disadvantage is anode feed gas which is lost in this way, i.e. lost fuel that is no longer available for electricity generation.

It is the object of the present invention to remedy, at least partially, the disadvantages described above. In particular, it is the object of the present invention to improve the control of the purging process in a fuel cell system in a cost-effective and simple way.

The above object is achieved by a sensor device with the features of claim 1, a fuel cell system with the features of claim 9 and a method with the features of claim 13.

Further features and details of the invention emerge from the dependent claims, the description and the drawings. Features and details which are described in connection with the sensor device according to the invention naturally also apply in connection with the fuel cell system according to the invention as well as the method according to the invention and vice versa, so that with regard to disclosure, mutual reference is or can always made to the individual aspects of invention.

According to the invention, a sensor device for a fuel cell system is designed to determine a purging parameter for controlling a purging process of the fuel cell system. For this purpose, the sensor device has a first flow channel for arranging in an anode feed section of an anode section of a fuel cell stack. The sensor device is also equipped with a second flow channel for arranging in a recirculation section of the anode section of the fuel cell stack. The first flow channel and the second flow channel are separated from each other, at least in sections, by means of a gas-tight membrane. This membrane is designed to be permeable for protons and has an electrode section on both sides. The sensor device also has a measuring device for determining a fuel concentration difference, in particular of hydrogen, between the first flow channel and the second flow channel, as a purging parameter, based on an electrical voltage between the two electrode sections.

Within the context of this application, the functionality is explained in part on the basis of hydrogen as fuel. Naturally, the use of other fuels is also possible within the scope of the present invention.

In contrast to the known solutions, a sensor device is now designed to perform an integral determination of the fuel concentration difference between the two flow channels and thus between the anode feed section and the recirculation section. This is based in particular on the idea that the concentration in the anode feed section is basically known, since this is the supply of the fuel. If, for example, hydrogen is used as fuel, it can be assumed that a one hundred percent or virtually one hundred percent hydrogen concentration is present in the anode feed section. The hydrogen concentration in the recirculation section depends on how large the degree of contamination is. Over the course of operation of the fuel cell, the impurities add up, so that the proportion of the contamination increases, as a result of which the proportion of hydrogen in the recirculation section decreases.

By means of a sensor device according to the invention, it is now possible to determine this concentration difference. This is based on an electrical potential between the first flow channel and the second flow channel. If there is a hydrogen concentration difference between the first flow channel and the second flow channel, this has effects on the membrane and the electrode sections placed thereon. The concentration difference leads to the protons and electrons in the first flow channel formed from the hydrogen, in particular on a catalyst layer, being moved through the membrane, which is designed to be permeable for protons, and electrodes which are conductive for the electrons in order to produce a chemical concentration balance with respect to the second flow channel. Because these protons have to move in order to pass through the membrane, and also because the electrons have to move through the two electrode sections, an electrical potential is created between the electrode section in the first flow channel and the electrode section in the second flow channel. This electrical potential described above can be measured between the two electrode sections via the measuring device and, as an electrical voltage, define a purging parameter. The measured electrical voltage between the two electrodes can be used directly as purging parameter. However, a further processing of this determined voltage value can also take place in order to allow a conclusion to be drawn as to the concentration difference and in particular a determination of the actual concentration of hydrogen in the second flow channel.

Based on the above explanation, the sensor device can thus be integrated into the fuel cell system. It is thus possible to monitor the concentration differences between the first flow channel and the second flow channel integrally within the fuel cell system and in particular in a continuous or substantially continuous manner. In addition to simply monitoring the difference, on the basis of a known concentration in the anode feed section a quantitative determination or at least a quantitative approximation of the hydrogen concentration in the recirculation section can actually take place. In contrast to the known solutions, it is no longer necessary to resort to a simulation model to start the purging processes. Rather, a determination of the hydrogen concentration and thus also a conclusion as to the degree of contamination in the recirculation section is possible. The degree of contamination can now be used as a control parameter to trigger a purging process.

The integral determination of a purging parameter on the basis of actually existing and measured differences in the concentration of hydrogen means that unnecessary purging processes can be avoided. Instead, it is sufficient if purging is carried out precisely when the degree of contamination of the recirculation gas exceeds a predefined degree, for example a specified value. Such targeted purging processes thus avoid unnecessary purging processes carried out for precautionary reasons on the basis of simulation results, so that the hydrogen loss due to such unnecessary purging processes can also be avoided. In addition, due to the precise knowledge of the concentration, in particular in the recirculation section, a significantly more dynamic control of the hydrogen supply in the anode feed section, in particular from a hydrogen source, is possible. This means that a load requirement for the fuel cell can be varied more dynamically and, above all, more flexibly. Last but not least, it should also be pointed out that targeted purging processes reliably avoid an excessive degree of contamination, in particular an excessive degree of nitrogen in the recirculation section and thus also in the anode feed section. An excessive nitrogen content could otherwise lead to degradation of the anode section of the fuel cell stack.

For the arrangement of the sensor device within the anode feed section and within the recirculation section, the respective flow channels are preferably designed with corresponding inputs and outputs in order to be integrated in a fluid-communicating manner in the anode feed section and the recirculation section. The first flow channel is designed to be gas-tight with respect to the second flow channel.

It can bring advantages if, in a sensor device according to the invention, the electrode sections cover the entire membrane or substantially the entire membrane on both sides. This is to be understood to the effect that no bypass of protons next to the electrodes is possible. In addition, a simple means of producing the membrane can be made available in this way, since this can also be produced in large sheets and then cut to size. By avoiding the bypass for protons described above, a significantly more accurate measurement and thus an improved determination of the purging parameter is possible.

Further advantages can be achieved if, in a sensor device according to the invention, the first flow channel and the second flow channel are identical or substantially identical in design, in particular with respect to the flow conditions. This includes, for example, identical flow cross-sections of the two flow channels. Identical or substantially identical design can also be understood to include identical overall volumes of the two flow channels. In particular, wall surfaces that influence the flow in the two flow channels as well as the corresponding inlet and outlet cross-sections are also identical or substantially identical. This means that a simplified evaluation of the determined concentration differences or the electrical voltage determined by means of the measuring device is possible.

In addition, it is also advantageous if, in a sensor device according to the invention, the first flow channel and/or the second flow channel have at least one actuating device for controlling the flow conditions in the respective flow channel. Such an actuating device can, for example, be designed as a valve or as a pump and leads to an equalisation of the flow conditions on both sides. In order to make possible an improved and above all a simplified evaluation for the purging parameter on the measuring device, the flow conditions in the two flow channels can be actively adapted. In particular, if the degree of recirculation is changed an equalisation of the flow conditions in the sensor device can be made available with the help of the actuating device. Even if different flow conditions arise due to different feed speeds or feed mass flows in the anode feed section under different load conditions or load requirements for the fuel cell system, an equalisation of the flow conditions can be made possible through the corresponding actuating device in the second flow channel.

It is also advantageous if, in a sensor device according to the invention, the at least one actuating device comprises at least one of the following modules:
pressure module for varying the gas pressure in the respective flow channel,
mass flow module for varying the mass flow in the respective flow channel.

The above list is a non-exhaustive list. A pressure module or a mass flow module can for example be understood to mean pump devices, pressure control devices or control valves. This makes it possible to influence the gas pressure and/or the mass flow, preferably both, in the respective flow channel and to adapt these to the corresponding conditions in the other flow channel. Preferably, such actuating devices are provided for both flow channels to provide a greater flexibility in the variation of the flow conditions and in the possibility of equalisation.

It is also advantageous if, in a sensor device according to the invention, the membrane has on at least one side, in particular on both sides, preferably on the respective electrode section, a catalyst layer for oxidising gas components, in particular hydrogen. This oxidation is to be understood as a chemical oxidation, so that, for example, protons and electrons are generated from hydrogen. The catalytic conversion of gas components through chemical oxidation means that even further improved preconditions for the formation of an electrical voltage are provided through a chemical potential between the two flow channels. In particular, the catalyst layers on both electrode sections are identical or substantially identical in form.

It can also be advantageous if, in a sensor device according to the invention, the membrane is designed to be electrically insulating. This can be made available through appropriate material properties of the membrane. However, it is also conceivable that the membrane provides the electrical insulation via a coating or a corresponding connection to walls or to a housing. It is particularly preferred if the membrane is in correspondingly electrically-insulating contact with one or even two electrode sections.

It is also advantageous if, in a sensor device according to the invention, the first flow channel and the second flow channel flow along the membrane in parallel. This means that concentration shifts which are otherwise possible due to counterflow are avoided and an undesirable variation due to temperature differences within the two flow channels is reduced.

The object of the present invention also includes a fuel cell system having
at least one fuel cell stack with an anode section and a cathode section,
an anode feed section for feeding anode feed gas to the anode section,
a cathode feed section for feeding cathode feed gas to the cathode section,
an anode discharge section for discharging at least a part of the anode exhaust gas,
a cathode discharge section for discharging cathode exhaust gas,
a recirculation section for returning at least a part of the anode exhaust gas to the anode feed section.

A sensor device according to the present invention is thereby provided. The anode feed section contains the first flow channel of the sensor device and the recirculation section contains the second flow channel of the sensor device. Thus, a fuel cell system according to the invention brings the same advantages as have been explained in detail in relation to a sensor device according to the invention. Naturally, the fuel cell system can have even more features. For example, the sensor section may be arranged upstream of a reformer device which converts supplied reformer feed gas into a reformed anode feed gas. Further components such as heat exchangers, afterburners or pole burner devices can also be used in such a fuel cell system within the scope of the present invention.

It can also be advantageous if, in a fuel cell system according to the invention, a mixing section is arranged downstream of the flow direction of the recirculated anode exhaust gas to introduce the recirculated anode exhaust gas into the anode feed section. In other words, a mixing of the recirculation gas and the anode feed gas takes place in the mixing section. This makes possible a simple and cost-effective mixing and combination of these two gases. The arrangement downstream of the second flow channel means that the mixing takes place after the determination of the purging parameter according to the invention has taken place. In addition to a mixing, a separate line leading to the anode section from the second flow channel would also be conceivable within the scope of the present invention.

It also brings advantages if, in a fuel cell system according to the invention, the mixing section in the anode feed section is arranged downstream of the first flow channel in the flow direction of the anode feed gas. This means that only after the anode feed gas has flowed through the first flow channel does a mixture with the recirculation gas take place. The influence of the recirculation gas and thus the resulting mixing concentration thus only takes place when the first flow channel has already been passed. This means that an exact composition can in particular be determined for the recirculation gas if the pure anode feed gas is known and this also flows in pure form through the first flow channel. In this way, undesirable cross-influences and deviations that build up over time are avoided for the first flow channel.

It can also be advantageous if, in a fuel cell system according to the invention, the mixing section in the anode feed section is arranged upstream of the first flow channel in the flow direction of the anode feed gas. This makes it possible to compare, not the pure gas component of the anode feed gas, but rather the already-adjusted mixture with the recirculation gas. This is particularly advantageous if not only one sensor device but two sensor devices are provided. For example, it brings great advantages if a first sensor device is arranged before the mixing section and a second sensor device after the mixing section, so that it becomes possible to provide both a comparison with the pure anode feed gas and with the mixed anode feed gas via chemical potential detection and corresponding purging parameters.

The object of the present invention also includes a method for controlling a fuel cell system according to the invention, having the following steps:
determining a purging parameter by means of the sensor device,
comparing the determined purging parameter with a specified value,
carrying out a purging process on the basis of the comparison.

A method according to the invention thus brings the same advantages as have been explained in detail in relation to a fuel cell system according to the invention. A purging process can thereby be a purging process or also a bleeding process. It is also conceivable that the purging parameter or the degree of deviation from the specified value decides whether a purging process or a bleeding process should be carried out.

It is also advantageous if, in a method according to the invention, a secondary parameter, in particular in the form of a nitrogen concentration in the second flow channel, is determined on the basis of the purging parameter. This is particularly advantageous if pure or substantially pure anode feed gas, for example pure hydrogen, is present in the first flow channel. The secondary parameter can thus generate, as a difference, the exact percentage of contamination, in particular in the form of nitrogen, without the nitrogen or nitrogen content having to be determined directly. The secondary parameter can be used on its own, but also combined with the purging parameter, as the comparison value in order to control the purging process.

Further advantages, features and details of the invention emerge from the following description, in which exemplary embodiments of the invention are described in detail with reference to the drawings. The features mentioned in the claims and in the description can in each case be essential to the invention, taken individually or in any combination. In each case schematically:

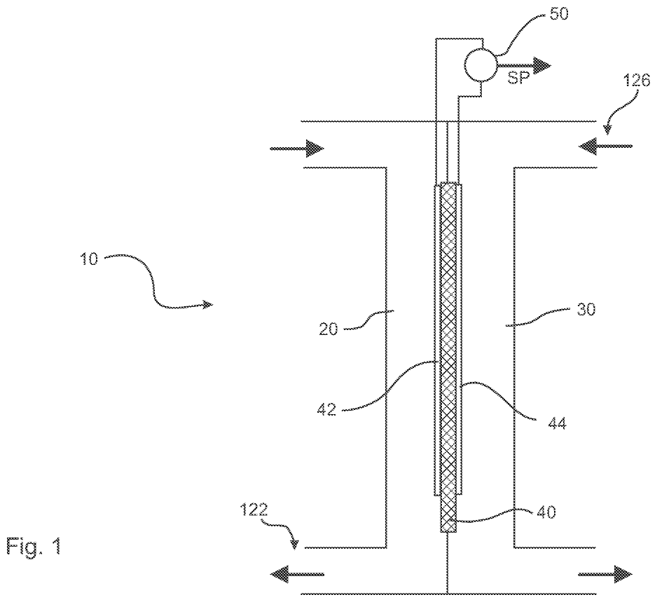

FIG. 1 shows an embodiment of a sensor device according to the invention,

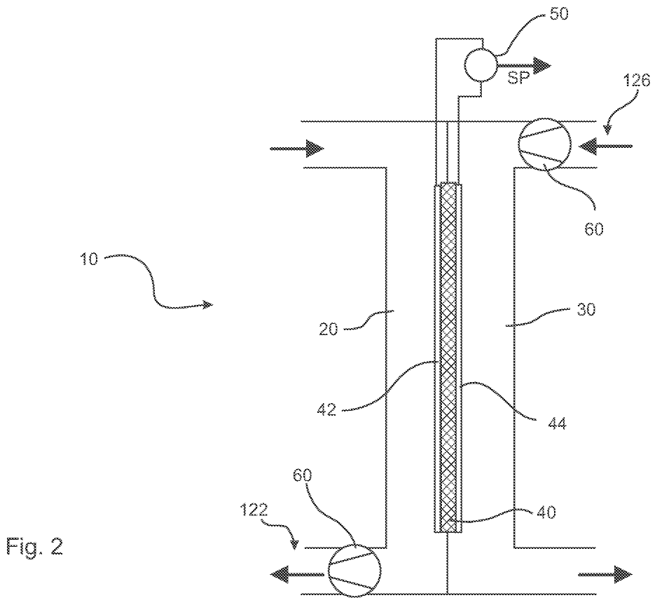

FIG. 2 shows a further embodiment of a sensor device according to the invention,

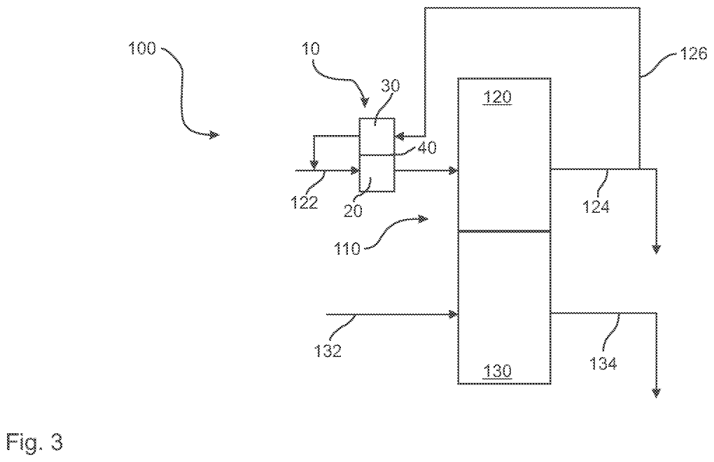

FIG. 3 shows an embodiment of a fuel cell system according to the invention,

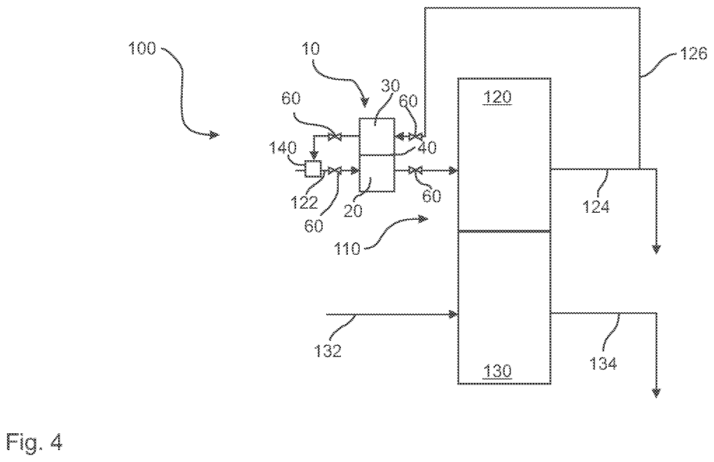

FIG. 4 shows a further embodiment of a fuel cell system according to the invention,

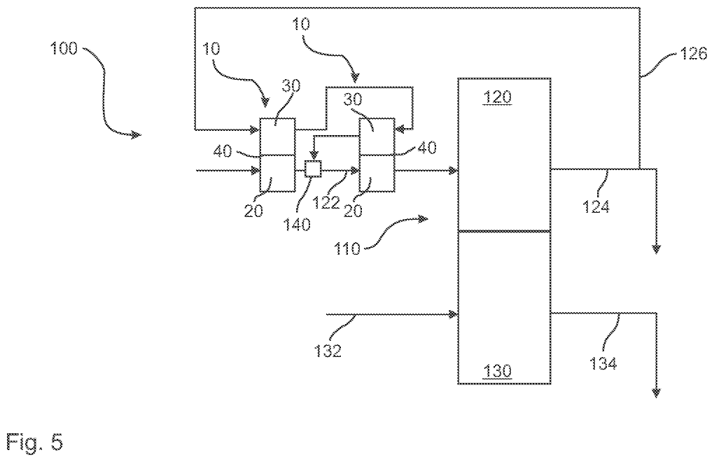

FIG. 5 shows a further embodiment of a fuel cell system according to the invention,

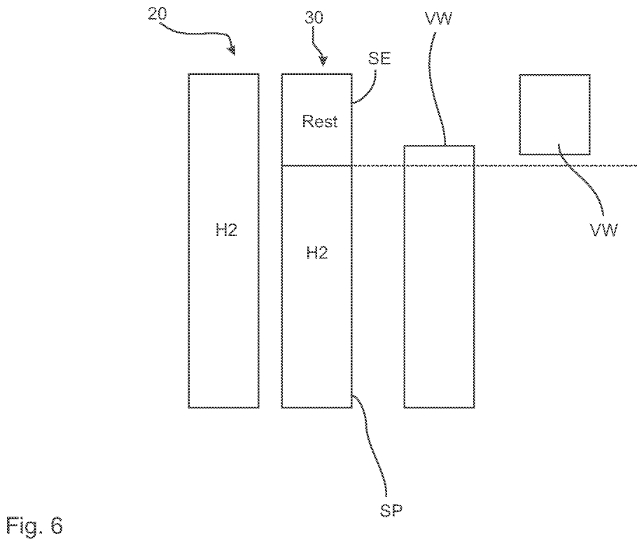

FIG. 6 shows a schematic representation of the method according to the invention.

FIG. 1 shows, schematically, the basic structure of a sensor device according to the invention. The sensor device has two individual cells which are characterised by a first flow channel 20 and a second flow channel 30. The first flow channel 20 is part of an anode feed section 122 and the second flow channel 30 is part of a recirculation section 126. Preferably, pure anode feed gas, for example pure hydrogen, flows through the first flow channel 20. Accordingly, recirculation gas contaminated by the anode exhaust gas is conducted through the second flow channel 30, so that a chemical concentration difference is established between hydrogen in the first flow channel 20 and in the second flow channel 30. In this embodiment, as shown in FIG. 1, the two flow channels 20 and 30 are separated by a gas-tight membrane 40. However, protons can penetrate through this membrane 40, so that a chemical concentration difference leads to an electrically measurable voltage between the first flow channel 20 and the second flow channel 30. This voltage is picked up via the electrode sections 42 and 44 arranged on both sides of the membrane 40 and can be detected by the measuring device 50. In the measuring device 50, the detected concentration difference can now be output as the purging parameter SP, or the measured voltage value can also be output directly. As can be clearly seen in FIG. 1, in this case the first flow channel 20 and the second flow channel 30 flow in parallel.

FIG. 2 shows a further development of a sensor device according to the invention. This is essentially based on the solution shown in FIG. 1. However, actuating devices 60 are additionally provided here, which are in the form of pump devices. This makes it possible to vary the flow conditions in the first flow channel 20 and in the second flow channel 30. Especially with different load requirements, but also with different recirculation quantities, an adjustment of the flow conditions in the other flow channel 20 or 30 can be carried out in this way, so that an equalisation, and in particular an equalisation of the flow conditions between the two flow channels 20 and 30 is possible.

FIG. 3 shows the integration of a sensor device 10 according to the invention in a fuel cell system 100 according to the invention. This is represented here schematically, with a fuel cell stack 110 with an anode section 120 and a cathode section 130. The anode section 120 is provided with an anode feed section for feeding anode feed gas and an anode discharge section 124 for discharging anode exhaust gas. In the same way, the cathode section 130 is designed with a cathode feed section 132 for feeding cathode feed gas and a cathode discharge section 134 for discharging cathode exhaust gas. As has already been explained, a residue of hydrogen is still present in the anode exhaust gas of the anode section 120 which is not discharged into the environment, but is instead intended to be recycled. This recycling is achieved through the recirculation of at least a part of the anode exhaust gas with the help of the recirculation section 126.

FIG. 3 shows how a sensor device 10 is integrated into the anode feed section 122 and the recirculation section 126. The anode exhaust gas recirculated through the recirculation section 126 is conducted into the second flow channel 30 and is present there in a concentration difference with respect to the anode feed gas of the first flow channel 20. Naturally, it is also possible to feed the recirculation gas downstream of the sensor device 10. This makes possible the integral determination of the concentration difference, so that a purging or bleeding process can be carried out with targeted precision.

FIG. 4 shows a further development of the embodiment shown in FIG. 1. In this embodiment, regulating valves or control valves are provided in the feed and discharge paths to the sensor device 10 as an actuating device 60 to equalise the flow conditions in the first flow channel 20 and in the second flow channel 30. A mixing section 140 is also provided which allows a mixing of the recirculation gas with the pure feed gas to be carried out with targeted precision. Naturally, the mixing section 140 can also be arranged downstream of the second flow channel 20 in the anode feed section 122.

FIG. 5 shows an embodiment with a further improvement of the fuel cell system 100. Thus, two sensor devices 10 are provided here which carry out their determination at two different points in relation to the mixing section 140. Thus, the left-hand sensor device 10 is able to determine the concentration difference between the pure anode feed gas and the recirculation gas. The right-hand sensor device 10 allows a determination between the recirculation gas and the already mixed anode feed gas. This means that an even more precise integral determination and thus an even more precise control of the purging and/or bleeding processes can be made available.

FIG. 6 shows, schematically, how a method according to the invention can be carried out. A hundred percent hydrogen concentration H2 is preferably present in the first flow channel 20. The second flow channel 30 is contaminated by a residue, for example by water vapour and/or by nitrogen and/or by carbon monoxide and/or carbon dioxide, so that the hydrogen concentration H2 is lower than in the first flow channel 20. The hydrogen concentration can now be determined as the purging parameter SP. On comparing this with a specified value VW according to FIG. 6, it is noticeable that the hydrogen concentration, as the purging parameter SP, has fallen below the specified value VW, so that the residue and thus the degree of contamination is too high and a purging process is necessary. In the same way, in addition or alternatively, it is possible to determine a secondary parameter SP for the residue, for example a nitrogen concentration. This can also be compared with a specified value VW, which according to FIG. 6 is, in this example, too high, so that too much contamination is present and a purging process is likewise necessary. Naturally, these two comparison steps can also be combined with each other in a method according to the invention.

The above explanation describes the present invention exclusively in the context of examples. Naturally, individual features of the present embodiments can be combined with each other freely without departing from the scope of the present invention.

### LIST OF REFERENCE SIGNS

10 sensor device
20 first flow channel
30 second flow channel
40 membrane
42 electrode section
44 electrode section
50 measuring device
60 actuating device
100 fuel cell system
110 fuel cell stack
120 anode section
122 anode feed section
124 anode discharge section
126 recirculation section
130 cathode section
132 cathode feed section
134 cathode discharge section
140 mixing section
SP purging parameter
SE secondary parameter
VW specified value

1. Sensor device (10) for a fuel cell system (100) for determining a purging parameter (SP) for controlling a purging process of the fuel cell system (100), comprising a first flow channel (20) for arranging in an anode feed section (122) of an anode section (120) of a fuel cell stack (110) and a second flow channel (130) for arranging in a recirculation section (126) of the anode section (120) of the fuel cell stack (110), which are separated from each other, at least in sections, by means of a gas-tight membrane (40), wherein the membrane (40) is designed to be permeable for protons and has an electrode section (42, 44) on both sides, as well as comprising a measuring device (50) for determining a fuel concentration difference, in particular of hydrogen, between the first flow channel (20) and the second flow channel (30) as a purging parameter (SP) based on an electrical voltage between the two electrode sections (42, 44).

2. Sensor device (10) according to claim 1, characterised in that the electrode sections (42, 44) cover the entire or substantially the entire membrane (40) on both sides.

3. Sensor device (10) according to claim 1, characterised in that the first flow channel (20) and the second flow channel (30) are identical or substantially identical in design, in particular with respect to the flow conditions.

4. Sensor device (10) according to claim 1, characterised in that the first flow channel (20) and/or the second flow channel (30) have at least one actuating device (60) for controlling the flow conditions in the respective flow channel (20, 30).

5. Sensor device (10) according to claim 4, characterised in that the at least one actuating device (60) comprises at least one of the following modules:
pressure module for varying the gas pressure in the respective flow channel (20, 30)
mass flow module for varying the mass flow in the respective flow channel (20, 30).

6. Sensor device (10) according to claim 1, characterised in that the membrane (40) has on at least one side, in particular on both sides, preferably on the respective electrode section (42, 44), a catalyst layer for oxidising gas components, in particular hydrogen.

7. Sensor device (10) according to claim 1, characterised in that the membrane (40) is designed to be electrically insulating.

8. Sensor device (10) according to claim 1, characterised in that the first flow channel (20) and the second flow channel (30) flow along the membrane (40) in parallel.

9. Fuel cell system (100), having:
at least one fuel cell stack (110) with an anode section (120) and a cathode section (130),
an anode feed section (122) for feeding anode feed gas to the anode section (120),
a cathode feed section (132) for feeding cathode feed gas to the cathode section (130),
an anode discharge section (124) for discharging at least a part of the anode exhaust gas,
a cathode discharge section (134) for discharging cathode exhaust gas,
a recirculation section (126) for returning at least a part of the anode exhaust gas into the anode feed section (122),
wherein a sensor device (10) with the features of claim 1, is also provided and the anode feed section (122) contains the first flow channel (20) of the sensor device (10) and the recirculation section (126) contains the second flow channel (30) of the sensor device (10).

10. Fuel cell system (100) according to claim 9, characterised in that a mixing section (140) is arranged downstream of the second flow channel (30) in the flow direction of the recirculated anode exhaust gas to introduce the recirculated anode exhaust gas into the anode feed section (122).

11. Fuel cell system (100) according to claim 10, characterised in that the mixing section (140) in the anode feed section (122) is arranged downstream of the first flow channel (20) in the flow direction of the anode feed gas.

12. Fuel cell system (100) according to claim 10, characterised in that the mixing section (40) in the anode feed section (122) is arranged upstream of the first flow channel (20) in the flow direction of the anode feed gas.

13. Method for controlling a purging process of a fuel cell system (100) with the features of claim 9, having the following steps:
determining a purging parameter (SP) by means of the sensor device (10),
comparing the determined purging parameter (SP) with a specified value (VW),
carrying out a purging process on the basis of the comparison.

14. Method according to claim 13, characterised in that a secondary parameter (SE), in particular in the form of a nitrogen concentration in the second flow channel (30), is determined on the basis of the purging parameter (SP).
